(19) United States
(12) Patent Application Publication
(10) Pub. No.: US 2007/0089118 A1
(43) Pub. Date: Apr. 19, 2007

(54) Method and device for controlling communications, and computer product

(75) Inventor: Tetsuo Aizaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/345,743

(22) Filed: Feb. 2, 2006

(30) Foreign Application Priority Data
Oct. 4, 2005 (JP) 2005-291408

(51) Int. Cl. G06F 9/46; G06F 9/44

(52) U.S. Cl. 719/330

(57) ABSTRACT

A gateway unit is provided between a client Application Program (AP) and a server AP. The gateway unit includes a client linking unit that receives an RPC request from the client AP, a server linking unit that receives a response from the server AP, and a server AP activating unit that activates the server AP that executes an application consisting of multiple sessions. The client linking unit and the server linking unit update and refer to session control data that is stored in a storage unit to carry out session control. The server linking unit receives the response from the server AP in the form of a request to the server linking unit.

### BACKGROUND OF THE INVENTION

1. Field of the Invention

The present invention relates to a technology for controlling communications pertaining to Remote Procedure Call (RPC) data communication between a client program loaded in a client device and a server program loaded in a server device.

2. Description of the Related Art

Remote Procedure Call (RPC) system is widely used as a technology to realize a distributed Operating System (OS) environment.

For example, a client program loaded in a client device calls via a network, a “remote procedure” that is provided by a server program loaded in a server device. The client program can call the “remote procedure” by using a similar sequence as the sequence that is used when calling a regular “local procedure”.

Japanese Patent Laid-Open Publication No 2002-197007 discloses the RPC. A relay server relays an RPC request issued by the client program to the server program, and responses from the server program are accumulated in the relay server. Japanese Patent Laid-Open Publication No H11-65861 discloses a gateway device. The gateway device converts session control signals that are not compatible with the distributed OS environment to session control signals that are compatible with the distributed OS environment.

However, the aforementioned sequence in which the client program issues an RPC request to the server program and the server program responds to the RPC request (hereinafter, “session”), is repeated several times to execute a single application. Due to this, a session control function that controls a plurality of sessions needs to be provided in a conventional server program.

When constructing a client/server type system by using an object oriented language, an object that realizes the session control function is provided, thereby removing the necessity to provide the session control function in the server program itself. However, when carrying out system development while inheriting assets of a client/server type system that is constructed by using a non object oriented language, a server program that includes the session control function needs to be created. The server program, which is created by using the non object oriented language, must be terminated when issuing an RPC response to the client program.

Due to this, when using the server program created by using the non object oriented language, data that is used for session control needs to be stored in a database (DB), and inherited for the next session.

However, the drawback that necessitates termination of the server program during an RPC response cannot be overcome by using the technology disclosed in the above references. Thus, the server program must be terminated during the RPC response even when the technology disclosed in the above references 2 is used.

Due to the aforementioned restriction pertaining to termination of the server program, a logic related to session control (for example, data inheritance for the next session) needs to be embedded into the server program, thereby increasing complexity of the server program.

Thus, a communication control method is called for that removes the necessity of terminating the server program during an RPC response and removes the necessity of embedding the logic related to session control into the server program.

### SUMMARY OF THE INVENTION

It is an object of the present invention to at least solve the problems in the conventional technology.

According to an aspect of the present invention, a method for carry out communication control pertaining to Remote Process Call (RPC) data communication between a client program that is loaded in a client device and a server program that is loaded in a server device includes controlling session data that represents a relation of a session corresponding to each RPC request that is issued by the client program; and relaying the RPC data communication between the client program and the server program based on the session data.

According to another aspect of the present invention, a communication control device for carry out communication control pertaining to Remote Process Call (RPC) data communication between a client program that is loaded in a client device and a server program that is loaded in a server device includes a controlling unit configured to control session data that represents a relation of a session corresponding to each RPC request that is issued by the client program; and a relaying unit configured to relay the RPC data communication between the client program and the server program based on the session data.

According to another aspect of the present invention, a computer-readable recording medium stores therein a computer program that implements the method according to the present invention on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A and FIG. 1B are drawings for explaining the outline of a communication control method according to an embodiment of the present invention;

FIG. 2 is a detailed block diagram of a server device shown in FIG. 1A or 1B;

FIG. 3 is a schematic for explaining contents of session control data;

FIG. 4 is a time series sequence for explaining linking of all the units;

FIG. 5 is a flowchart of a processing procedure performed by a client linking unit shown in FIG. 2;

FIG. 6 is a flowchart of a processing procedure performed by a server AP activating unit shown in FIG. 2;

FIG. 7 is a flowchart of a processing procedure performed by a server linking unit shown in FIG. 2; and

FIG. 8A through FIG. 8C are block diagrams for explaining variations in positioning of a gateway unit.

### DETAILED DESCRIPTION OF THE PREFERRED EMBODIMENTS

Exemplary embodiments of the present invention are explained next with reference to the accompanying drawings. The communication control method applied to a server device is explained next.

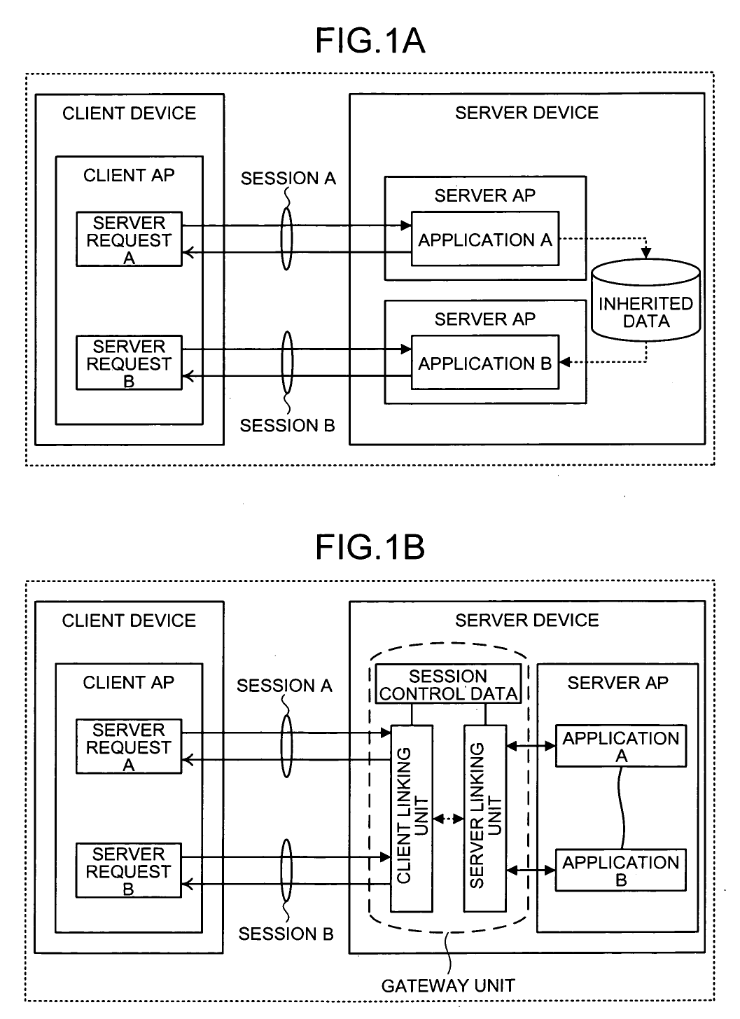

An outline of the communication control method according to the present invention is explained first with reference to FIG. 1A and FIG. 1B. FIG. 1A is drawing for explaining the outline of a conventional communication control method, and FIG. 1B is a drawing for explaining the outline of the communication control method according to the embodiment. In both the methods, a client application program (client AP) loaded in a client device issues a Remote Process Call (RPC) request to a server application program (server AP) loaded in a server device.

The process includes, for example, a session A and a session B. How the client device makes a request to perform the process is explained next. As shown in FIG. 1A, in the conventional method, the server AP corresponding to the session A itself returns an RPC response to a server request A (RPC request). Therefore, operations of the server AP corresponding to the session A needs to be stopped when returning the RPC response.

When the operations of the server AP are stopped, a storage area that is used by that server AP to store data required in the next session (session B) is released. In other words, the data in the storage area is lost. To avoid this situation, in the conventional method, the data in the storage area, is transferred in a database (DB) as inherited data, so that the server AP corresponding to the session B can read the inherited data from the DB. After reading the data, the server AP corresponding to the session B carries out the session B and returns a response (RPC response) related to the session B. Because the conventional method requires storing and reading of the inherited data, its puts extra burden on persons who develop computer programs or who maintain the server AP.

On the contrary, as shown in FIG. 1B, according to the embodiment, a gateway unit is provided between the client AP and the server AP, and the gateway unit carries out session control. As a result, there is no need to embed a logic related to session control into the server AP.

The gateway unit includes a client linking unit and a server linking unit. The client linking unit receives an RPC request from the client AP and returns a response (RPC response) to the received RPC request. The server linking unit receives a response from the server AP as an RPC request and notifies the client linking unit. The client linking unit and the server linking unit update and refer to session control data that is stored in a storage unit to carry out session control of multiple sessions.

Because the server linking unit receives a response from the server AP in the form of a request to the server linking unit, the server AP can execute a response to the client AP in the form of a request to the server linking unit instead of in the form of an RPC response. In other words, the server AP does not need to carry out a termination process when executing the RPC response. Thus, the server AP can inherit the data that is commonly used between multiple applications (Application A and Application B) via the storage area that is used by the server AP.

Thus, in the embodiment, the gateway unit arranged between the client AP and the server AP carries out session control, thereby removing the necessity to embed the logic for session control into the server AP. Further, the server AP can issue a response to the request from the client AP in the form of a request to the server linking unit instead of in the form of an RPC response, thereby removing the necessity to terminate the server AP when issuing a response to the client AP, and removing the necessity to embed into the server AP the logic pertaining to the storing process and the reading process of the inherited data that is used during multiple sessions.

By using the communication control method according to the present invention, a process that is carried out by the server AP can be distributed to the original application, thereby enabling to efficiently reduce the development person hours and the maintenance person hours pertaining to the server AP. Especially, unlike the sever AP that is developed by using an object oriented language, providing an object (for example, by using framework such as Enterprise Java (registered trademark) Beans (EJB)) to carry out session control is difficult in the server AP that is developed by using a non object oriented language. Thus, applying the communication control method according to the present invention to the server AP that is developed by using the non object oriented language is highly effective.

Although the gateway unit is provided in the server device in FIG. 1B, the gateway unit can be provided as an independent device in a network or can also be provided on the client device.

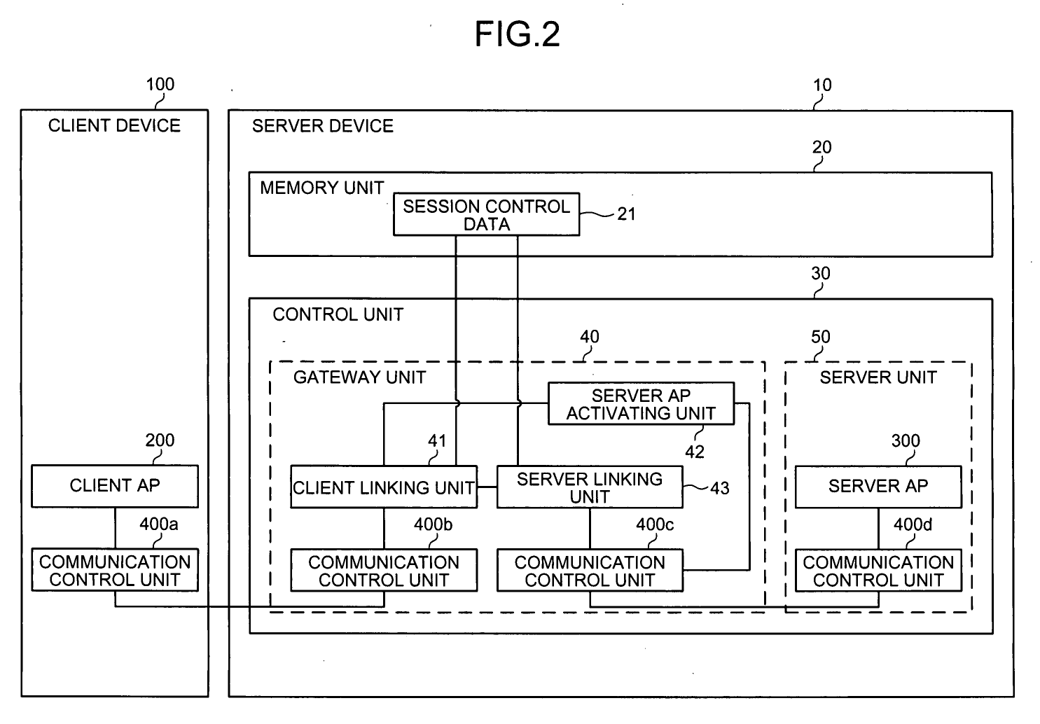

The server device that uses the communication control method according to the present invention is explained next with reference to FIG. 2. FIG. 2 is a block diagram of a structure of a server device 10. A client device, a server unit and communication control units that are used in the conventional communication control method can be used respectively as a client device 100 and a server unit 50 and communication control units 400a through 400d that are included in the server device 10 shown in FIG. 2. As shown in FIG. 2, a gateway unit 40 is provided on the server device 10. However, the gateway unit 40 can also be provided as an independent device or provided on the client device 100.

The client device 100 is a computer such as a personal computer. The client device 100 includes a client AP 200 having a server access function, and a communication control unit 400a that carries out data communication with the server device 10 via a network.

The client AP 200 is a computer program that issues an RPC request to the server device 10 via the communication control unit 400a. When executing a single application, the client AP 200 issues multiple RPC requests, and executes the application by using response data of each RPC request.

The communication control unit 400a includes a communication device such as a Local Area Network (LAN) board. The communication control unit 400a carries out interactive data communication between the client device 100 and the server device 10. For example, the communication control unit 400a carries out transceiving of data by replacing issue of an RPC request or an RPC response with issue of a send function or a receive function respectively in socket communication.

The server device 10 is a computer such as a server computer that provides data by responding to requests from the client device 100. The server device 10 includes a storage unit 20 and a control unit 30. The storage unit 20 stores session control data 21 that controls multiple sessions.

The control unit 30 is further provided with the gateway unit 40 and the server unit 50. The gateway unit 40 is further provided with a client linking unit 41, a server AP activating unit 42, a server linking unit 43, a communication control unit 400b, and a communication control unit 400c. The server unit 50 is further provided with a server AP 300, and a communication control unit 400d.

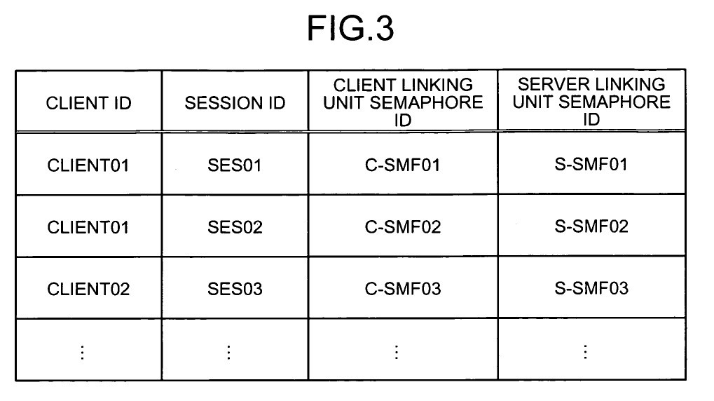

The storage unit 20 is a memory device such as a Random Access Memory (RAM). The storage unit 20 stores the session control data 21 that controls multiple sessions. The session control data 21 is explained in detail with reference to FIG. 3. FIG. 3 is a drawing illustrating an example of the session control data 21.

As shown in FIG. 3, the session control data 21 includes a “client ID”, a “session ID”, a “client linking unit semaphore ID”, and a “server linking unit semaphore ID” that are provided in a record pertaining to each session. The session control data 21 in a table format is explained in the present embodiment. However, the session control data 21 can also be provided in the form of a link list that corresponds to each of the client ID, the session ID, the client linking unit semaphore ID, and the server linking unit semaphore ID.

The client ID is an identifier that identifies a client program that issues an RPC request. The session ID is an identifier that identifies a session pertaining to an RPC request. The client linking unit semaphore ID is an identifier that identifies a semaphore that is used by each execution pertaining to the client linking unit 41. The server linking unit semaphore ID is an identifier that identifies a semaphore that is used by each execution pertaining to the server linking unit 43.

As shown in FIG. 3, for example, two records having the session ID “SES01” and the session ID “SES02” respectively have the same client ID “CLIENT01”. In other words, the client AP 200, which corresponds to CLIENT01, requests an application consisting of two sessions to the server AP 300. An execution by the client linking unit 41 corresponds to a session having the session ID “SES01” and uses a semaphore having the semaphore ID “C-SMF01”. Similarly, an execution by the server linking unit 43 uses a semaphore having the semaphore ID “S-SMF01”.

In the present embodiment the client linking unit 41 and the server linking unit 43 use semaphores to receive and distribute data and to terminate or resume a process. However, the client linking unit 41 and the server linking unit 43 can also use system calls other than the semaphores to carry out similar processes.

The control unit 30 includes the gateway unit 40 and the server unit 50. The gateway unit 40 is the salient feature of the present embodiment. As shown in FIG. 2, the gateway unit 40 is connected to both the client AP 200 of the client device 100 and the server AP 300 of the server unit 50. The gateway unit 40 carries out session control.

The client linking unit 41 fetches an RPC request from the client AP 200 via the communication control unit 400b, and notifies the server AP activating unit 42 of request data that is included in the fetched RPC request. Further, the client linking unit 41 gets a response from the server AP 300 via the server linking unit 43 and returns the response in the form of an RPC response to the client AP 200. The client linking unit 41 also fetches a semaphore that is used by the client linking unit 41 itself, and records in the session control data 21 of the storage unit 20, the semaphore ID of the fetched semaphore and the client ID and the session ID (see FIG. 3) that are related to the RPC request that is fetched from the client AP 200.

An execution by the client linking unit 41 is, generated as a process or a thread for every RPC request of the client AP 200. The client linking unit 41, upon notifying the server AP activating unit 42 of the request data, uses the fetched semaphore to carry out a waiting process (hereinafter, “WAIT”), terminates WAIT upon receiving a response from the server linking unit 43, and transmits the RPC response to the client AP 200. The execution by the client linking unit 41 terminates after the RPC response is transmitted.

Based on the instruction from the client linking unit 41, the server AP activating unit 42 activates the server AP 300 corresponding to the RPC request, and notifies the activated server AP 300 of the request data that is included in the initial RPC request. If a request consisting of multiple sessions is issued to the specific server AP 300, an execution pertaining to the server AP activating unit 42 is generated for each session group consisting of multiple sessions. The server AP 300 is activated during the initial session and terminated when the final session is terminated.

The server linking unit 43 fetches response data from the server AP 300 in the form of an RPC request, and notifies the client linking unit 41 of the response data that is included in the fetched RPC request. The server linking unit 43 fetches a semaphore that is used by the server linking unit 43 itself, and records the semaphore ID of the fetched semaphore in the corresponding record in the session control data 21 of the storage unit 20.

An execution pertaining to the server linking unit 43 is generated as a process or a thread for every response from the server AP 300. If the execution corresponds to a session other than the final session in the session group, the server linking unit 43 notifies the client linking unit 41 of the response data, carries out WAIT using the fetched semaphore, terminates WAIT upon receiving request data pertaining to the next session from the client linking unit 41, and notifies the server AP 300 of the request data, thereby terminating the execution. If the execution corresponds to the final session in the session group, the execution terminates after the client linking unit 41 is notified of the response data.

The communication control unit 400b is similar to the communication control unit 400a of the client device 100. The communication control unit 400a receives an RPC request that is issued by the client AP 200 via the communication control unit 400a, and distributes the received RPC request to the client linking unit 41. Further, the communication control unit 400b receives an RPC response that is issued by the client linking unit 41, and transmits the received RPC response to the client AP 200 via the communication control unit 400a.

The communication control unit 400c is similar to the communication control unit 400a of the client device 100. The communication control unit 400c receives data from the server AP activating unit 42 or the server linking unit 43 and notifies the server AP 300 of the received data via the communication control unit 400d of the server unit 50. Further, the communication control unit 400c also distributes to the server AP activating unit 42 or the server linking unit 43 the data that is transmitted by the server AP 300 via the communication control unit 400d.

The server unit 50 includes the server AP 300 and the communication control unit 400d. The server unit 50 is equivalent to the server device shown in FIG. 1a. The server AP 300 gets an RPC request from the client AP 200 via the gateway unit 40, and returns a response to the request. However, when returning a response to the gateway unit 40, the server AP 300 returns an RPC request that includes response data instead of returning an RPC response (response to an RPC request). Thus, even when executing an application consisting of multiple sessions, the server AP 300 does not need to be terminated until a string of sessions is completed, thereby removing the necessity of a process (logic) related to data inheritance.

The communication control unit 400d is similar to the communication control unit 400a of the client device 100. The communication control unit 400d carries out interactive data communication with the communication control unit 400c of the gateway unit 40.

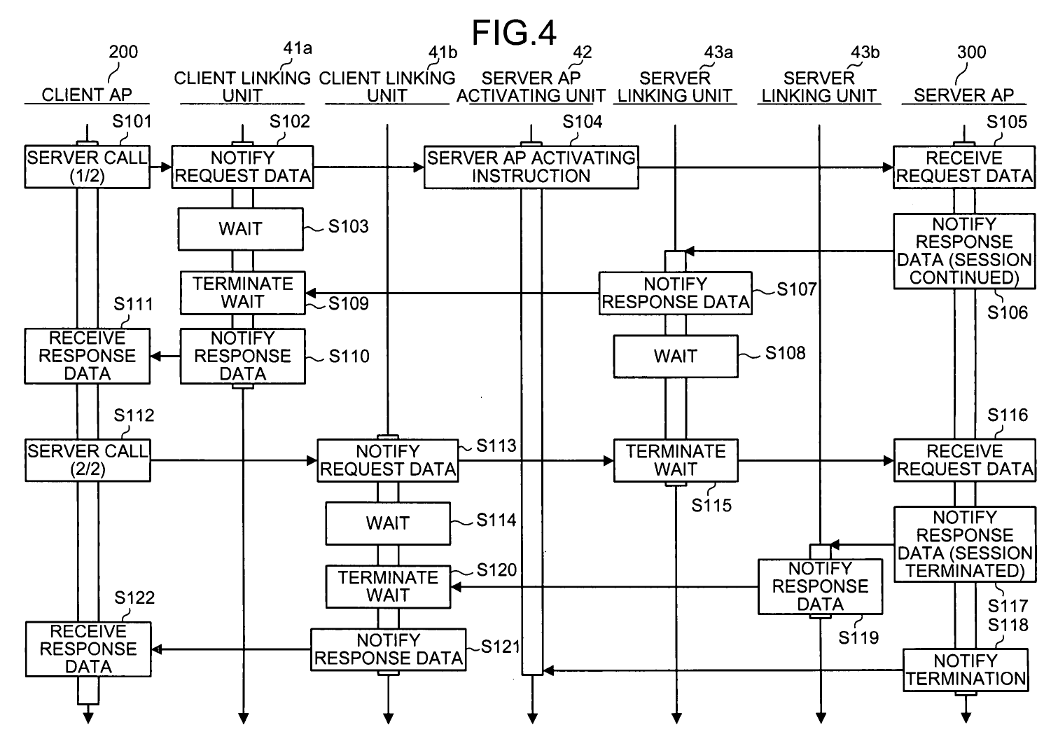

A relation between all the units (see FIG. 2) according to the present embodiment is explained next with reference to FIG. 4. FIG. 4 is a drawing illustrating a time series sequence of linking of all the units. As shown in FIG. 4, a server request that is issued by the client AP 200 and includes two sessions (RPC request/response) is explained. 41a and 41b indicate executions by the client linking unit 41 shown in FIG. 2. Similarly, 43a and 43b indicate executions by the server linking unit 43 shown in FIG. 2.

As shown in FIG. 4, when the client AP 200 makes a first server call (RPC request) (step S101), the client linking unit 41a which receives the RPC request notifies the server AP activating unit 42 of request data that is included in the RPC request (step S102), and carries out WAIT by using a semaphore corresponding to the client linking unit semaphore ID shown in FIG. 3 (step S103). The server AP activating unit 42 that receives the notification notifies the server AP 300 of a server AP activating instruction that includes the request data (step S104), thereby activating the corresponding server AP 300.

Next, the server AP 300 receives the request data that is included in the server AP activating instruction (step S105), generates response data by carrying out predetermined applications, and activates the server linking unit 43a by using the created response data (step S106). After notifying the server linking unit 43a of the response data, the server AP 300 awaits receiving of next data without terminating.

The server linking unit 43a that is activated by the server AP 300 and gets the response data generated by the server AP 300 notifies the client linking unit 41a of the response data (step S107) and carries out WAIT by using a semaphore corresponding to the server linking unit semaphore ID shown in FIG. 3 (step S108).

The client linking unit 41a that receives the notification pertaining to the response data terminates WAIT by using the semaphore (step S109) and notifies the client AP 200 of the response data in the form of an RPC response (step S110). The client AP 200 that gets the RPC response (step S111) carries out applications by using the response data and makes a second server call (RPC request) (step S112).

The client linking unit 41b that receives the server call (RPC request) notifies the server linking unit 43a of the request data that is included in the RPC request (step S113) and carries out WAIT by using a semaphore corresponding to the client linking unit semaphore ID (step S114). The server linking unit 43a that gets the request data from the client linking unit 41b terminates WAIT by using the semaphore (step S115) and notifies the server AP 300 of the request data.

Next, the server AP 300 receives the request data from the server linking unit 43a (step S116), generates response data by carrying out predetermined applications, and activates the server linking unit 43b by notification of the generated response data (step S117). Based on session data that is included in the request data, the server AP 300 determines that the session is the final session and transmits a termination notification to the server AP activating unit 42 (step S118), thereby terminating the session.

The server linking unit 43b that receives the response data from the server AP 300 notifies the client linking unit 41b of the response data (step S119). The client linking unit 41b that receives the response data from the server linking unit 43b terminates WAIT by using the semaphore (step S120) and notifies the client AP 200 of the response data in the form of an RPC response (step S121). The client AP 200 that receives the RPC response (step S122) carries out predetermined applications.

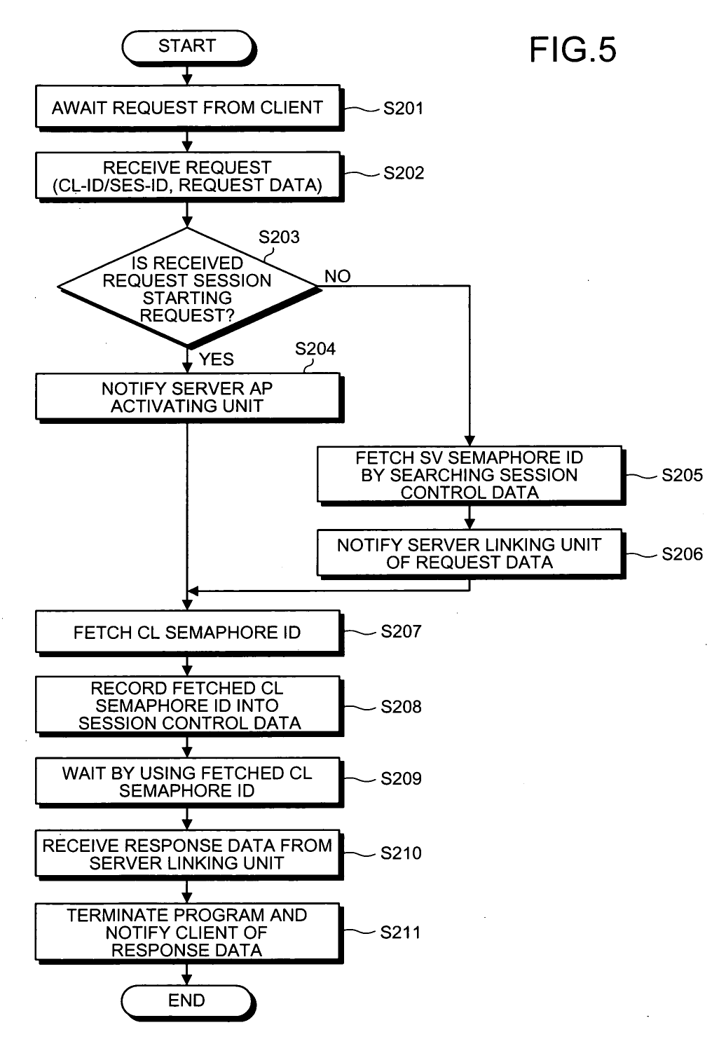

Sequences of processes executed by the client linking unit 41, the server AP activating unit 42, and the server linking unit 43 are explained next with reference to FIG. 5 through FIG. 7. As shown in FIG. 5 through FIG. 7, the client ID, the session ID, the client linking unit semaphore ID, and the server linking unit semaphore ID are indicated by the abbreviations “CL-ID”, “SES-ID”, “CL semaphore ID”, and “SV semaphore ID” respectively.

A sequence of a process by the client linking unit 41 is explained with reference to FIG. 5. FIG. 5 is a flow chart of the sequence of the process by the client linking unit 41. The sequence of the process by the client linking unit 41 shown in FIG. 5 is carried out by each execution that is generated by the client linking unit 41.

As shown in FIG. 5, the client linking unit 41 awaits a request from a client (the client AP 200) (step S201), and upon receiving a request (step S202), determines whether the received request is a session starting request (step S203). The request received at step S202 is data that includes a CL-ID, an SES-ID, and request data.

If the received request is the session starting request at step S203 (“Yes” at step S203), the client linking unit 41 notifies the server AP activating unit 42 (step S204) and fetches a CL semaphore ID (step S207). If the received request is not the session starting request at step S203 (if the client linking unit 41 determines that the session is the second session or a subsequent session in the session group) (“No” at step S203), the client linking unit 41 searches the session control data 21, fetches an SV semaphore ID (step S205), notifies the server linking unit 43 of the request data (step S206), and fetches a CL semaphore ID (step S207).

Next, the client linking unit 41 records in the session control data 21 the CL semaphore ID fetched at step S207 (step S208) and carries out WAIT by using the semaphore corresponding to the CL semaphore ID fetched at step S207 (step S209). Upon receiving the response data from the server linking unit 43 (execution that is generated by the server linking unit 43) (step S210), the client linking unit 41 terminates WAIT, terminates itself, and notifies the client (the client AP 200) of the response data in the form of an RPC response (step S211).

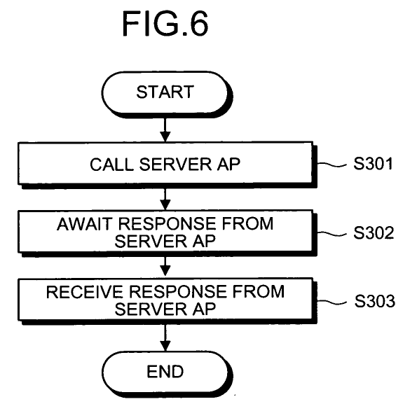

A sequence of a process by the server AP activating unit 42 is explained next with reference to FIG. 6. FIG. 6 is a flow chart of the sequence of the process by the server AP activating unit 42. The sequence of the process by the server AP activating unit 42 shown in FIG. 6 is carried out by each execution that is generated by the server AP activating unit 42.

As shown in FIG. 6, upon receiving the request data from the client linking unit 41, the server AP activating unit 42 calls the server AP 300 (step S301). Next, the server AP activating unit 42 awaits a response from the server AP 300 (step S302), and upon receiving a response from the server AP 300 (step S303), terminates the process.

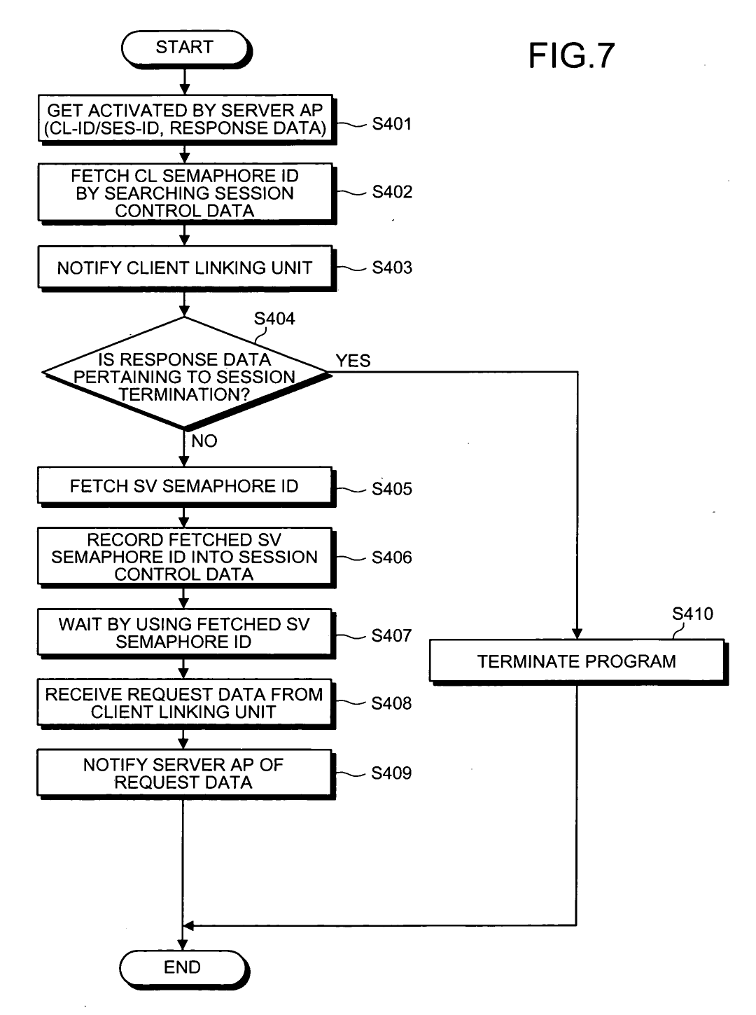

A sequence of a process by the server linking unit 43 is explained next with reference to FIG. 7. FIG. 7 is a flow chart of the sequence of the process by the server linking unit 43. The sequence of the process by the server linking unit 43 shown in FIG. 7 is carried out by each execution that is generated by the server linking unit 43.

As shown in FIG. 7, the server linking unit 43, upon getting activated by the server AP 300 (step S401) searches the session control data 21 to fetch a CL semaphore ID (step S402). The server linking unit 43 gets a CL-ID, an SES-ID, and response data upon getting activated at step S401.

Next, the server linking unit 43 notifies the client linking unit 41 of the response data (execution corresponding to the CL semaphore ID that is fetched at step S401) (step S403) and determines whether the response data is response data pertaining to session termination (step S404). If the response data is not response data pertaining to session termination (“No” at step S404), the server linking unit 43 carries out a process to fetch an SV semaphore ID (step S405). If the response data is response data pertaining to session termination (“Yes” at step S404), the server linking unit 43 terminates the program (step S410).

Continuing the process from step S405 onwards, the server linking unit 43 records in the session control data 21 the fetched SV semaphore ID (step S406), and carries out WAIT by using a semaphore corresponding to the fetched SV semaphore ID (step S407). Next, upon receiving the next request data from the client linking unit 41 (step S408), the server linking unit 43 terminates WAIT, notifies the server AP 300 of the request data (step S409), and terminates the process.

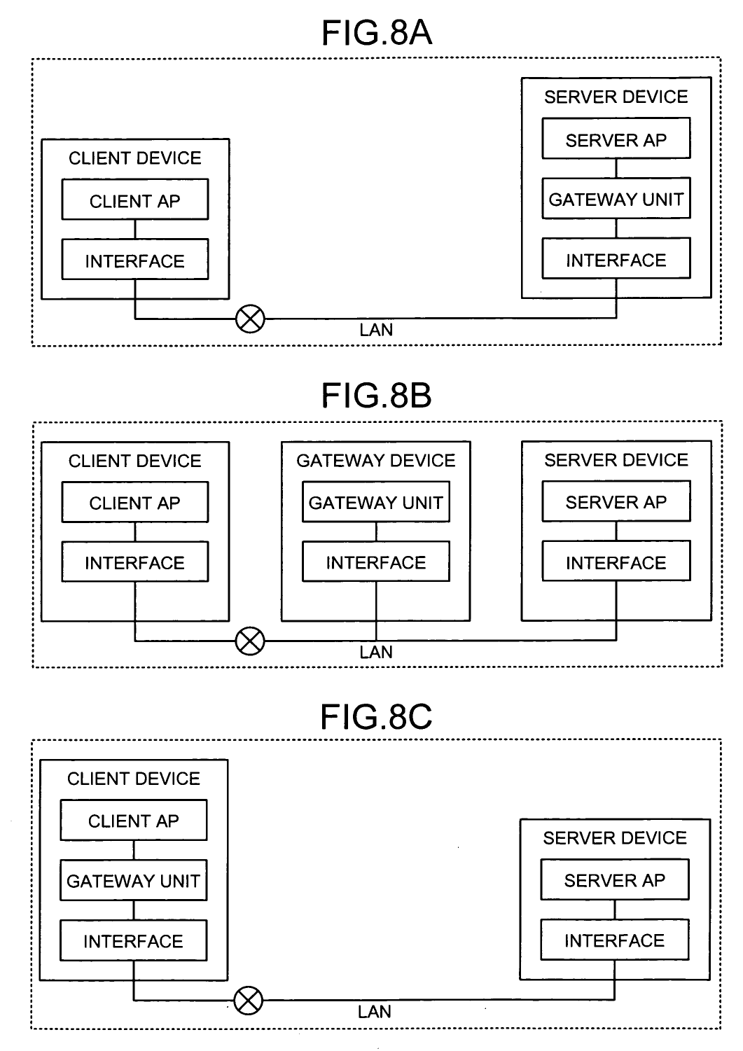

A variation in positioning of the gateway unit 40 according to the present embodiment is explained next with reference to FIG. 8A through FIG. 8C. FIG. 8A through FIG. 8C are drawings illustrating a variation in positioning of the gateway unit 40. FIG. 8A is a drawing of a positioning pattern corresponding to the block diagram shown in FIG. 2. Although providing the gateway unit 40 on the server device generally necessitates a large process space on the server device, the gateway unit 40 can be directly applied to a conventional client/server system, thereby enhancing the cost performance. However, the gateway unit 40 can also be provided on other devices.

For example, as shown in FIG. 8B, a gateway device that includes the gateway unit 40 can be connected to the network. As shown in FIG. 8C, the gateway unit 40 can also be provided on the client device.

In the embodiment explained above, the gateway unit is provided between the client AP and the server AP. The gateway unit includes the client linking unit that receives an RPC request from the client AP, the server linking unit that receives a response from the server AP, and the server AP activating unit that activates the server AP that executes an application consisting of multiple sessions. The client linking unit and the server linking unit update and refer to session control data from the storage unit to carry out session control, thereby enabling to remove logic related to session control from the server AP. Further, the server linking unit receives a response from the server AP in the form of a request to the server linking unit, thereby removing the need to terminate the server AP when returning a response. Thus, necessity of a process related to data inheritance spread over the sessions is removed, thereby enhancing development efficiency and maintenance efficiency of the server AP.

According to the embodiment, a computer executes a session data control process that controls session data that represents a relation of a session corresponding to each Remote Process Call (RPC) request that is issued by a client program, and a relay process that carries out, based on the session data that is controlled by the session data control process, a relay of RPC data communication between the client program and a server program, thereby enabling to realize session control without embedding a logic pertaining to session control into the server program, thus enabling to enhance development efficiency and maintenance efficiency of the server program.

Moreover, the relay process receives a response from the server program to the RPC request in the form of an RPC request to the relay process instead of receiving in the form of an RPC response to an RPC request that is issued by the client program, thereby removing the need to terminate the server program when returning an RPC response, thus enabling to eliminate unnecessary processes in the original application such as a storing process and a reading process of inherited data that is used during multiple sessions.

Furthermore, the relay process causes the computer to further execute a client linking process that generates for every RPC request, a client linking execution that carries out a relay of request data to the server program and a response to the client program, and a server linking process that generates for every response, a server linking execution that relays a response of the server program to the client linking execution, thereby enabling to easily carry out session control.

Moreover, the session data control process that controls the session data that represents the relation of a session corresponding to each RPC request that is issued by the client program, and the relay process that carries out, based on the session data that is controlled by the session data control process, relay of the RPC data communication between the client program and the server program are provided, thereby enabling to realize session control without embedding the logic pertaining to session control into the server program, thus enabling to enhance development efficiency and maintenance efficiency of the server program.

Furthermore, the session data control process that controls the session data that represents the relation of a session corresponding to each RPC request that is issued by the client program, and the relay process that carries out, based on the session data that is controlled by the session data control process, relay of the RPC data communication between the client program and the server program are provided, thereby enabling to realize session control without embedding the logic pertaining to session control into the server program, thus enabling to enhance development efficiency and maintenance efficiency of the server program.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to carry out communication control pertaining to Remote Process Call (RPC) data communication between a client program that is loaded in a client device and a server program that is loaded in a server device, the computer program causing the computer to execute:
controlling session data that represents a relation of a session corresponding to each RPC request that is issued by the client program; and
relaying the RPC data communication between the client program and the server program based on the session data.

2. The computer-readable recording medium according to claim 1, wherein the relaying includes receiving, a response from the server program to the RPC request, in the form of an RPC request to the relaying instead of receiving in the form of an RPC response to an RPC request that is issued by the client program.

3. The computer-readable recording medium according to claim 1, wherein the relaying includes
generating for every RPC request a client linking execution that carries out relaying of request data to the server program and a response to the client program; and
generating for every response a server linking execution that relaying a response of the server program to the client linking execution.

4. The computer-readable recording medium according to claim 3, wherein
the client linking execution includes, based on the RPC request that is received from the client program, a relation between the session corresponding to the RPC request and other sessions, and an identifier that identifies the client linking execution, and
the server linking execution notifies the client linking execution corresponding to the identifier that is fetched from the session data that is controlled at the controlling, of a response that is received from the server program.

5. The computer-readable recording medium according to claim 4, wherein the server linking execution includes the identifier that identifies the server linking execution, and a client linking execution that is newly generated at the generating the client linking process notifies, provided that the identifier related to the server linking execution is recorded in the session data that is controlled at the controlling, the server linking execution corresponding to the identifier, of request data.

6. The computer-readable recording medium according to claim 5, wherein the identifiers in the client linking execution and the server linking execution are semaphores for waiting, and the client linking execution and the server linking execution use the semaphores to await a response from the client linking execution or the server linking execution.

7. A method for carry out communication control pertaining to Remote Process Call (RPC) data communication between a client program that is loaded in a client device and a server program that is loaded in a server device, the method comprising:
controlling session data that represents a relation of a session corresponding to each RPC request that is issued by the client program; and
relaying the RPC data communication between the client program and the server program based on the session data.

8. The method according to claim 7, wherein the relaying includes receiving, a response from the server program to the RPC request, in the form of an RPC request to the relaying instead of receiving in the form of an RPC response to an RPC request that is issued by the client program.

9. The method according to claim 7, wherein the relaying includes
generating for every RPC request a client linking execution that carries out relaying of request data to the server program and a response to the client program; and
generating for every response a server linking execution that relaying a response of the server program to the client linking execution.

10. A communication control device for carry out communication control pertaining to Remote Process Call (RPC) data communication between a client program that is loaded in a client device and a server program that is loaded in a server device, the device comprising:
a controlling unit configured to control session data that represents a relation of a session corresponding to each RPC request that is issued by the client program; and
a relaying unit configured to relay the RPC data communication between the client program and the server program based on the session data.

11. The communication control device according to claim 10, wherein the relaying unit receives, a response from the server program to the RPC request, in the form of an RPC request to the relaying instead of receiving in the form of an RPC response to an RPC request that is issued by the client program.

12. The communication control device according to claim 10, wherein the relaying unit includes
a client linking execution generating unit that generates for every RPC request a client linking execution that carries out relaying of request data to the server program and a response to the client program; and
a server linking execution generating unit that generates for every response a server linking execution that relaying a response of the server program to the client linking execution.

13. The communication control device according to claim 10, wherein the communication control device is the server device wherein the server program is loaded.
